(19) United States
(12) Patent Application Publication
(10) Pub. No.: US 2009/0088511 A1
(43) Pub. Date: Apr. 2, 2009

(54) ELECTROLESS PLATING LIQUID

(75) Inventors: Tomohisa Konno, Tokyo (JP); Taichi Matsumoto, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: JSR CORPORATION, Chuo-ku, Tokyo (JP)

(21) Appl. No.: 12/282,993

(22) PCT Filed: Mar. 13, 2007
(86) PCT No.: PCT/JP2007/054957

§ 371 Date: Sep. 15, 2008

(30) Foreign Application Priority Data
Mar. 15, 2006 (JP) 2006-071451
Mar. 15, 2006 (JP) 2006-071452
Mar. 15, 2006 (JP) 2006-071453
Mar. 15, 2006 (JP) 2006-071454

(51) Int. Cl. C08K 3/08

(52) U.S. Cl. 524/440

(57) ABSTRACT

The electroless plating solution of the present invention is an electroless plating solution used for selectively forming a protective film on a surface of an exposed wiring in the production of a semiconductor device having a wiring structure, wherein
the electroless plating solution includes a cobalt ion, an ion of a second metal other than cobalt, a chelating agent, a reducing agent, a surface active agent and a specific tetraalkylammonium hydroxide, and
the surface active agent is selected from the group consisting of a compound represented by the following formula (2a) or (2b), a sulfonic acid type anionic surface active agent, a polyoxyethylene alkyl ether phosphoric ester and a polyoxyalkylene monoalkyl ether,

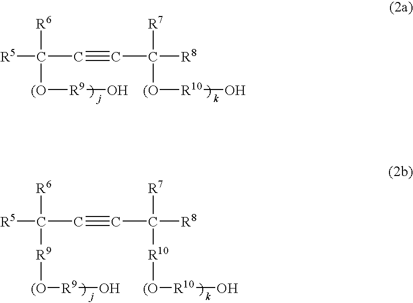

wherein R⁵ to R⁸ are each a hydrogen atom or a specific alkyl group, R⁹ and R¹⁰ are each an alkylene group of 2 to 5 carbon atoms, j and k are each independently an integer of not less than 1, and the sum of j and k is 2 to 50.

According to the present invention, a protective film uniformly having a diffusion-preventing ability can be formed on a copper wiring with high selectivity.

### TECHNICAL FIELD

The present invention relates to an electroless plating solution used for selectively forming a protective film on a surface of an exposed wiring in the production of a semiconductor device having a wiring structure using copper or a copper alloy as a wiring material.

### BACKGROUND ART

Aluminum-based alloys have been mainly used conventionally for fine wirings of high-density integrated circuits formed on semiconductor substrates. However, use of copper, a copper alloy or the like having lower specific resistance than the aluminum-based alloys as a wiring material has been needed for higher speed semiconductor devices. In particular, copper has electromigration resistance higher than that of the aluminum-based alloys by about one order of magnitude, and therefore, copper is expected as a wiring material of a semiconductor device of the next generation.

As a process for forming a copper wiring of a semiconductor device, a process which comprises embedding of a metal in a wiring trench and a contact hole (damascene process) is adopted. This damascene process is a process wherein a metal such as copper or a copper alloy is embedded in a wiring trench or a contact hole formed in advance in an interlayer insulating film and then removal of an excess metal and planarizing of the film are performed by chemical mechanical polishing (CMP).

As for a wiring of this kind, the surface of the wiring is exposed outside after planarizing, and when an embedded wiring is formed on the wiring, an interlayer insulating film is further formed on the wiring and a wiring trench is formed therein. In this case, however, there are fears of surface contamination of the exposed wiring and electromigration into the interlayer insulating film stacked. On this account, a wiring protective film of silicon nitride or the like has been formed conventionally not only on the wiring part having an exposed surface but also on the whole surface of the semiconductor substrate.

However, the electromigration resistance at the interface between the silicon nitride film and copper is weak, and in addition, since the silicon nitride film itself has a high dielectric constant, there is a problem of increase of wiring delay (RC delay due to resistance R and capacity C). Then, it has been proposed to use cobalt-tungsten-phosphorus (CoWP) as a material which improves the RC delay, has excellent electromigration resistance and is effective for prevention of copper diffusion (U.S. Pat. No. 5,695,810 (patent document 1)).

This CoWP has an advantage that it can selectively form a film only on a copper wiring by electroless plating.

When the CoWP electroless plating is carried out, sodium hypophosphite is generally used as a reducing agent. However, it is known that sodium hypophosphite is an inert reducing agent which does not undergo reaction on copper, and therefore, if the sodium hypophosphite is used as a reducing agent, plating cannot be carried out directly on copper (e.g., G. O. Mallory, J. B. Hajdu, “Electroless Plating-Fundamentals & Applications-”, American Electroplaters And Surface Finishers Society, Florida, page 318, 1990) (non-patent document 1).

On that account, it is necessary to form the CoWP film by electroless plating after a seed layer of palladium or the like is formed on the copper wiring. However, there is concern that palladium that forms the seed layer as above may increase resistance of copper due to reaction with copper that forms the wiring layer. Moreover, palladium may adhere to a surface of an insulator in addition to the wiring, and the CoWP film is liable to be formed also on the surface of the insulator in addition to the copper wiring. This causes a problem that insulation between wirings required for forming fine wirings is lowered.

In order to avoid the influence on the copper wiring by such a reaction of palladium with copper as above, it is necessary to use a reducing agent requiring no palladium catalyst as a catalyst, and CoWB electroless plating methods using dimethylamine borane (DMAB) as such a reducing agent requiring no palladium catalyst have been proposed (U.S. Pat. No. 5,169,680 (patent document 2), Japanese Patent Laid-Open Publication No. 2003-49280 (patent document 3)). Dimethylamine borane (DMAB), however, has strong reducing ability, so that stability of the electroless plating solution is deteriorated, and because of such instability of the electroless plating solution, there is a problem that cobalt may be deposited also on places other than the copper wiring.

For the purpose of controlling stability of a plating bath and a deposition rate, an anionic, cationic or nonionic surface active agent is generally added to the electroless plating solution. As substances effective for excellent stability of a plating bath or optimization of a deposition rate, polyoxyethylene octylphenyl ether, polyoxyethylene nonylphenyl ether, and sulfuric esters and phosphoric esters thereof may be used. These compounds, however, are considered or suspected to be endocrine disruptors (environmental hormones), and there is a fear of influence on the electroless plating workers and the surrounding environment.

Patent document 1: U.S. Pat. No. 5,695,810

Patent document 2: U.S. Pat. No. 5,169,680

Patent document 3: Japanese Patent Laid-Open Publication No. 2003-49280

Non-patent document 1: G. O. Mallory, J. B. Hajdu, “Electroless Plating-Fundamentals & Applications-”, American Electroplaters And Surface Finishers Society, Florida, page 318, 1990

### DISCLOSURE OF THE INVENTION

### Problem to be Solved by the Invention

It is an object of the present invention to solve such problems associated with the prior art as mentioned above and to provide an electroless plating solution which prevents deteriorating of reliability on semiconductor devices caused by contamination of wirings composed of copper and copper alloys and diffusion of copper and which can selectively form a protective film uniformly having a diffusion-preventing ability only on a wiring.

### Means to Solve the Problem

The electroless plating solution of the present invention is an electroless plating solution used for selectively forming a protective film on a surface of an exposed wiring in the production of a semiconductor device having a wiring structure, and comprises a cobalt ion, an ion of a second metal other than cobalt, a chelating agent, a reducing agent, a surface active agent and a tetraalkylammonium hydroxide represented by the following formula (1):

R¹R²R³R⁴NOH (1)

wherein R¹, R², R³ and R⁴ are each independently one group selected from the group consisting of an alkyl group and a hydroxyalkyl group, and

the surface active agent is selected from the group consisting of a compound represented by the following formula (2a) or (2b), a sulfonic acid type anionic surface active agent, a polyoxyethylene alkyl ether phosphoric ester and a polyoxyalkylene monoalkyl ether,

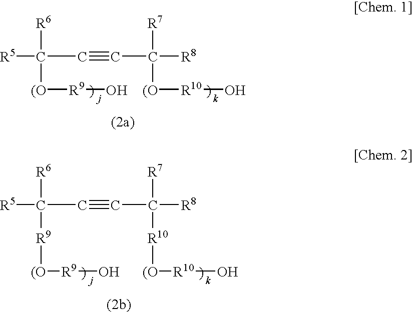

wherein R⁵ to R⁸ are each independently a hydrogen atom or a substituted or unsubstituted alkyl group of 1 to 5 carbon atoms, R⁹ is an alkylene group of 2 to 5 carbon atoms, and when a plurality of R⁹ are present, they may be the same as or different from one another, R¹⁰ is an alkylene group of 2 to 5 carbon atoms, and when a plurality of R¹⁰ are present, they may be the same as or different from one another, j and k are each independently an integer of not less than 1, and the sum of j and k is 2 to 50.

That is to say, embodiments of the electroless plating solution of the invention include the following four embodiments.

(1) An electroless plating solution used for selectively forming a protective film on a surface of an exposed wiring in the production of a semiconductor device having a wiring structure, which comprises a cobalt ion, an ion of a second metal other than cobalt, a chelating agent, a reducing agent, a compound represented by the following formula (2a) or (2b), and a tetraalkylammonium hydroxide represented by the following formula (1):

R¹R²R³R⁴NOH (1)

wherein R¹, R², R³ and R⁴ are each independently one group selected from the group consisting of an alkyl group and a hydroxyalkyl group,

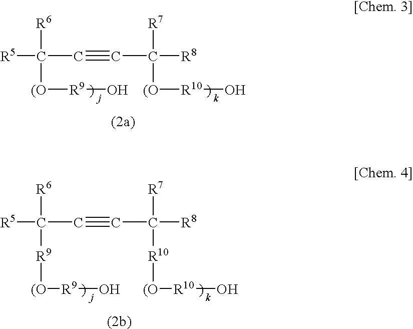

wherein R⁵ to R⁸ are each independently a hydrogen atom or a substituted or unsubstituted alkyl group of 1 to 5 carbon atoms, R⁹ is an alkylene group of 2 to 5 carbon atoms, and when a plurality of R⁹ are present, they may be the same as or different from one another, R¹⁰ is an alkylene group of 2 to 5 carbon atoms, and when a plurality of R¹⁰ are present, they may be the same as or different from one another, j and k are each independently an integer of not less than 1, and the sum of j and k is 2 to 50 (said electroless plating solution is also referred to as an “electroless plating solution (A)” hereinafter).

(2) An electroless plating solution used for selectively forming a protective film on a surface of an exposed wiring in the production of a semiconductor device having a wiring structure, which comprises a cobalt ion, an ion of a second metal other than cobalt, a chelating agent, a reducing agent, a sulfonic acid type anionic surface active agent, and a tetraalkylammonium hydroxide represented by the above formula (1) (said electroless plating solution is also referred to as an “electroless plating solution (B)” hereinafter).

(3) An electroless plating solution used for selectively forming a protective film on a surface of an exposed wiring in the production of a semiconductor device having a wiring structure, which comprises a cobalt ion, an ion of a second metal other than cobalt, a chelating agent, a reducing agent, a polyoxyethylene alkyl ether phosphoric ester, and a tetraalkylammonium hydroxide represented by the above formula (1) (said electroless plating solution is also referred to as an “electroless plating solution (C)” hereinafter).

(4) An electroless plating solution used for selectively forming a protective film on a surface of an exposed wiring in the production of a semiconductor device having a wiring structure, which comprises a cobalt ion, an ion of a second metal other than cobalt, a chelating agent, a reducing agent, a polyoxyalkylene monoalkyl ether, and a tetraalkylammonium hydroxide represented by the above formula (1) (said electroless plating solution is also referred to as an “electroless plating solution (D)” hereinafter).

The polyoxyethylene alkyl ether phosphoric ester contained in the electroless plating solution of the invention is preferably a compound represented by the following formula (3):

[R¹¹O—(CH₂CH₂O)ₙ]ₘ—H₃₋ₘPO₄₋ₘ (3)

wherein R¹¹ is a hydrocarbon group of 10 or more carbon atoms, n is an integer of not less than 5 and less than 30, and m is 1 or 2.

### EFFECT OF THE INVENTION

By use of the surface active agent selected from the group consisting of a compound represented by the above formula (2a) or (2b), a sulfonic acid type anionic surface active agent, a polyoxyethylene alkyl ether phosphoric ester and a polyoxyalkylene monoalkyl ether, the electroless plating solution of the invention exhibits excellent stability and can selectively form a protective film uniformly having a diffusion-preventing ability only on a wiring, without using palladium.

Further, by use of a compound represented by the above formula (1) as a pH adjustor, the pH value of the electroless plating solution can be adjusted with the pH adjustor containing no alkali metal, and by use of this electroless plating solution, a protective film containing no alkali metal can be formed.

### BEST MODE FOR CARRYING OUT THE INVENTION

Next, the electroless plating solution of the invention is described in detail.

The electroless plating solution of the invention is an electroless plating solution favorably used for forming a protective film containing cobalt and uniformly having a diffusion-preventing ability on a surface of a copper metal or a copper alloy.

As a source of supply of the cobalt ion contained in the electroless plating solution of the invention, a water-soluble cobalt(II) salt is used. Although the salt is not specifically restricted, examples thereof include cobalt sulfate, cobalt chloride, cobalt bromide, cobalt acetate, cobalt oxalate, cobalt nitrate and cobalt hydroxide.

These compounds can be used singly or in combination.

Among the above examples of the cobalt salts, cobalt sulfate, cobalt nitrate and cobalt hydroxide are preferable in the invention. The amount of the cobalt salt blended is properly determined according to the type of the cobalt salt used. Specifically, the amount of the cobalt salt is in the range of usually 0.001 to 1 mol/liter, preferably 0.01 to 1 mol/liter, in terms of cobalt ion.

In the electroless plating solution of the invention, a second metal ion is contained in addition to the cobalt ion.

In the present invention, the ion of the second metal other than cobalt is selected from ions of fourth period metals of the periodic table of elements other than cobalt, ions of fifth period metals of the periodic table of elements, ions of sixth period metals of the periodic table of elements, and ions of atomic groups containing these metals. Examples of the elements include:

(a) chromium, nickel, copper and zinc in the fourth period,

(b) molybdenum, technetium, ruthenium, rhodium, palladium and silver in the fifth period, and

(c) tungsten, rhenium, osmium, iridium, platinum and gold in the sixth period.

Among these second metals, tungsten and/or molybdenum is preferable in the invention.

Examples of sources of supply of the second metal ions in the invention include:

(a) metal oxides, such as tungsten dioxide, tungsten trioxide, molybdenum dioxide and molybdenum trioxide,

(b) metal salts, such as tungsten pentachloride and tungsten hexachloride, and

(c) heteropoly-acids and salts thereof, such as tungstic acid, molybdic acid, tungstate, molybdate and tungstophosphoric acid.

In the electroless plating solution of the invention, the second metal is used in an amount of usually 0.001 to 1 mol/liter, preferably 0.01 to 1 mol/liter, in terms of a metal having a valence of 0.

In order to stabilize the metal ions such as a cobalt ion, a chelating agent is blended with the electroless plating solution of the invention.

Examples of the chelating agents employable in the invention include common chelating agents, such as carboxylic acids and salts thereof, aminocarboxylic acids and salts thereof, and oxycarboxylic acids and salts thereof. Preferred examples of the chelating agents particularly employable in the electroless plating solution of the invention include acetic acid, glycine, citric acid, tartaric acid, ethylenediaminetetraacetic acid and salts of these acids, and pyrophosphoric acid and salts of this acid. Among these, citric acid is particularly preferable in the invention. In any case of the electroless plating solutions (A) to (D) of the invention, the above chelating agents can be used singly or in combination.

The amount of the chelating agent in the electroless plating solution of the invention is in the range of usually 0.001 mol/liter to 2 mol/litter, preferably 0.01 mol/liter to 1.5 mol/liter.

In order to deposit, as metals, the metal ions contained in the electroless plating solution of the invention, such as a cobalt ion and a second metal ion, on the surface of the exposed wiring (surface to be plated), reduction reaction is utilized. The reducing agent to promote the reduction reaction in the electroless plating solution of the invention is preferably a reducing agent containing no alkali metal such as sodium.

By use of such a reducing agent containing no alkali metal, an alkali metal is not incorporated into a film formed from the electroless plating solution of the invention, and a film having excellent film property can be formed.

Examples of such reducing agents include monoalkylamine borane, dialkylamine borane and trialkylamine borane. In any of the electroless plating solutions (A) to (D) of the invention, these reducing agents can be used singly or in combination. A specific example of the reducing agents is dimethylamine borane (or borane dimethylamine complex, referred to as “DMAB” hereinafter).

The reducing agent blended in the electroless plating solution of the invention, such as dimethylalkyl borane, not only is a reducing agent to deposit a cobalt ion and a second metal ion but also functions as a source of supply of boron (B) of the cobalt-based alloy (e.g., CoWB) that constitutes the electroless plating layer formed by deposition.

Preferred examples of the reducing agents in the invention include hypophosphorous acid and hypophosphite. Also in this case, the hypophosphorous acid and the hypophosphite that are reducing agents function as sources of supply of phosphorus (P) of the cobalt-based alloy (e.g., CoWP) that constitutes the electroless plating layer formed by deposition.

To the electroless plating solution of the invention, such a reducing agent as above is added in an amount of usually 0.001 mol/liter to 1 mol/litter, preferably 0.01 mol/liter to 1 mol/liter.

In order to secure stability of a plating bath, and besides, in order to control a deposition rate of a metal, a surface active agent is generally blended with an electroless plating solution.

The surface active agents blended with an electroless plating solution for the above purposes include an anionic surface active agent, a cationic surface active agent and a nonionic surface active agent. The surface active agents that have been employed as those particularly effective for securing stability of an electroless plating solution and optimizing a deposition rate of a metal include polyoxyethylene octylphenyl ether, polyoxyethylene nonylphenyl ether, and sulfuric esters or phosphoric esters thereof.

Such a surface active agent is necessary for smoothly carrying out electroless plating, but on the other hand, the above compounds generally used for an electroless plating solution are suspected to be endocrine disruptors (environmental hormones). Taking into account the influence on the electroless plating workers and the surrounding environment, it is desirable to use a surface active agent free from endocrine disrupting activity.

In the present invention, a surface active agent free from endocrine disrupting activity, such as a sulfonic acid type anionic surface active agent, a polyoxyethylene alkyl ether phosphoric ester or a polyoxyalkylene monoalkyl ether, is used, taking into account the influence on the electroless plating workers and the surrounding environment.

The compound represented by the formula (2a) or (2b) for use in the electroless plating solution (A) is a nonionic surface active agent.

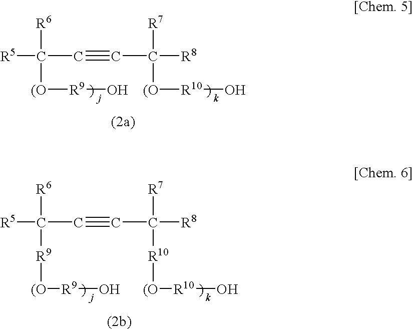

In the formula (2a) or (2b), R⁵ to R⁸ are each independently a hydrogen atom or a substituted or unsubstituted alkyl group of 1 to 5 carbon atoms. R⁹ is an alkylene group of 2 to 5 carbon atoms, and when plural alkylene groups indicated by R⁹ are present, they may be the same as or different from one another. R¹⁰ is an alkylene group of 2 to 5 carbon atoms, and when plural alkylene groups indicated by R¹⁰ are present, they may be the same as or different from one another. j and k are each independently an integer of not less than 1, the sum of j and k is preferably 2 to 50, and the upper limit of the sum of j and k is more preferably not more than 30.

Examples of the compounds represented by the formula (2a) in the invention include 2,4,7,9-tetramethyl-5-decyn-4,7-diol-dipolyoxyethylene ether (the sum of the numbers of repeating oxyalkylene units: 10) and 2,4,7,9-tetramethyl-5-decyn-4,7-diol-dipolyoxyethylene ether (the sum of the numbers of repeating oxyalkylene units: 30). These compounds can be used singly or in combination.

Preferred examples of the nonionic surface active agents represented by the formula (2a) include Surfynol 400 series available from Air Products and Chemicals, Inc. In the present invention, the nonionic surface active agent represented by the formula (2a) or (2b) may be used in combination with another surface active agent. The nonionic surface active agent may be used in combination with an anionic surface active agent, a cationic surface active agent or another nonionic surface active agent.

Specific examples of the sulfonic acid type anionic surface active agents for use in the electroless plating solution (B) include an alkylbenzenesulfonic acid, an alkyldiphenylethersulfonic acid, a naphthalenesulfonic acid formaldehyde condensate, and ammonium salts thereof. These compounds can be used singly or in combination. Further, they may be used in combination with other nonionic surface active agents.

The polyoxyethylene alkyl ether phosphoric ester for use in the electroless plating solution (C) is a nonionic type anionic surface active agent, and can be represented by the following formula (3).

[R¹¹O—(CH₂CH₂O)ₙ]ₘ—H₃₋ₘPO₄₋ₘ (3)

In the formula (3), R¹¹ is a hydrocarbon group of 10 or more carbon atoms, n is an integer of not less than 5 and less than 30, and m is 1 or 2.

In the formula (3), R¹¹ is an alkyl group of 10 or more carbon atoms, preferably an alkyl group of 10 to 30 carbon atoms, and examples thereof include a decyl group, an isodecyl group, a lauryl group, a tridecyl group, a cetyl group, an oleyl group and a stearyl group. In the formula (3), the groups indicated by R¹¹ may be the same groups, or may be plural groups combined. The molecular weight of such a polyoxyethylene alkyl ether phosphoric ester is usually not less than 400.

Specific examples of the polyoxyethylene alkyl ether phosphoric esters include phosphoric monoester of polyoxyethylene decyl ether, phosphoric diester of polyoxyethylene decyl ether, phosphoric monoester of polyoxyethylene isodecyl ether, phosphoric diester of polyoxyethylene isodecyl ether, phosphoric monoester of polyoxyethylene lauryl ether, phosphoric diester of polyoxyethylene lauryl ether, phosphoric monoester of polyoxyethylene tridecyl ether, and phosphoric diester of polyoxyethylene tridecyl ether. These compounds can be used singly or in combination. The polyoxyethylene alkyl ether phosphoric esters include monoesters and diesters, and in the present invention, the monoesters and the diesters may be each used singly or may be used as a mixture.

The polyoxyalkylene monoalkyl ether for use in the electroless plating solution (D) is a nonionic surface active agent. This polyoxyalkylene monoalkyl ether can be represented by the following formula (4).

R¹²—(OCH₂CHR¹³)ₙ—OH (4)

In the formula (4), R¹² is an alkyl group of 10 or more carbon atoms, R¹³ is a hydrogen atom or an alkyl group of 1 to 3 carbon atoms, and n is an integer of not less than 5 and less than 30. Examples of the alkyl groups of 10 or more carbon atoms as R¹² in the formula (4) include a decyl group, an isodecyl group, a lauryl group, a tridecyl group, a cetyl group, an oleyl group and a stearyl group. The alkyl groups as R¹² may be the same or different.

R¹³ is a hydrogen atom or an alkyl group of 1 to 3 carbon atoms, specifically a hydrogen atom, a methyl group, an ethyl group, an n-propyl group or an isopropyl group. These groups may be present singly or in combination. In the formula (2a) or (2b), n is an integer of not less than and less than 30, particularly preferably an integer of 5 to 20.

The molecular weight of such a polyoxyalkylene monoalkyl ether is usually not less than 400.

Such a polyoxyalkylene monoalkyl ether preferably has an HLB value (hydrophile-lipophile balance), as measured by Griffin method, of not less than 12.

Specific examples of the polyoxyalkylene monoalkyl ethers include polyoxyethylene decyl ether, polyoxyethylene isodecyl ether, polyoxyethylene lauryl ether, polyoxyethylene tridecyl ether, polyoxypropylene decyl ether, polyoxypropylene lauryl ether and polyoxypropylene tridecyl ether. Such polyoxyalkylene monoalkyl ethers can be used singly or in combination.

The amount of the surface active agent blended with the electroless plating solution of the invention is as follows. The amount of each of the compound represented by the formula (2a) or (2b), the sulfonic acid type anionic surface active agent, the polyoxythylene alkyl ether phosphoric ester and the polyoxyalkylene monoalkyl ether is in the range of usually 0.0001% by mass to 1% by mass, preferably 0.001% by mass to 0.5% by mass, based on 100% by mass of the whole electroless plating solution, and the total amount of these four surface active agents is in the range of usually 0.0001% by mass to 1% by mass, preferably 0.001% by mass to 0.5% by mass, based on 100% by mass of the whole electroless plating solution. By using the surface active agent in the above amount, the electroless plating solution has sufficient liquid stability, and besides, not only the metal deposition rate is optimized but also evil influence is not exerted on the workers and the environment. In the present invention, the surface active agents can be used singly or in combination. When the above surface active agents are used as a mixture, they can be mixed in any mixing ratio as long as the total amount of the surface active agents is in the above range.

In order to adjust a pH value, a tetraalkylammonium hydroxide is blended with the electroless plating solution. This tetraalkylammonium hydroxide can be represented by the following formula (1).

R¹R²R³R⁴NOH (1)

In the formula (1), R¹, R², R³ and R⁴ are each independently one group selected from the group consisting of an alkyl group and a hydroxyalkyl group.

This compound is a pH adjustor containing no alkali metal.

Examples of the compounds represented by the formula (1), which are used as pH adjustors in the invention, include tetramethylammonium hydroxide (referred to as “TMAH” hereinafter), tetraethylammonium hydroxide, tetrabutylammonium hydroxide, methyltriethylammonium hydroxide, ethyltrimethylammonium hydroxide, 2-hydroxyethyltrimethylammonium hydroxide and 2-hydroxyethyltriethylammonium hydroxide.

Such a compound represented by the formula (1) as above is used in such an amount that the pH value of the electroless plating solution of the invention can be adjusted in the range of usually 5 to 14, preferably 7 to 11.

In addition to the above components, additives publicly known, such as buffering agent, anti-corrosion agent and accelerator, can be added to the electroless plating solution of the invention, when needed. For example, boric acid can be mentioned as an additive that functions as a buffering agent and/or an accelerator.

As a method for forming a cobalt alloy plating film using the electroless plating solution of the invention, there can be adopted a method wherein a semiconductor substrate, whose surface to be plated has been subjected to necessary treatment such as cleaning in a conventional way, is immersed in the electroless plating solution at a liquid temperature of 20 to 100° C., preferably 35 to 90° C., until a plating film having a necessary thickness is formed.

As a wiring material to constitute the wiring structure formed on the semiconductor substrate, copper is generally employed. This copper film is not limited to a film of pure copper and may be composed of a copper alloy having a copper content of not less than 95% by mass, such as copper-silicon or copper-aluminum. This wiring is formed by a damascene process comprising coating an interlayer insulating film having a wiring trench formed therein with a barrier metal, e.g., a metal of high hardness, such as tantalum or titanium, and/or a nitride or an oxide thereof, then depositing the above wiring metal by electroplating or the like, and planarizing the semiconductor substrate with the deposited wiring metal by chemical mechanical polishing (CMP).

The metal to form the barrier metal film used herein is not limited to a pure metal and may be an alloy such as tantalum-niobium. When the barrier metal film is formed from a nitride, the nitride such as tantalum nitride or titanium nitride does not necessarily have to be a pure nitride. The material of the barrier metal film is particularly preferably tantalum and/or tantalum nitride. Although the barrier metal film is frequently formed from any one of tantalum and titanium, films of different materials, such as a tantalum film and a tantalum nitride film, may be both formed as barrier metal films on the same substrate.

Examples of the interlayer insulating films include a silicon oxide film formed by vacuum process such as chemical vapor deposition (PETEOS film (plasma enhanced TEOS film), HDP film (high-density plasma enhanced TEOS film), silicon oxide film obtained by thermal CVD method, or the like), a boron phosphorus silicate film (BPSG film) wherein small amounts of boron and phosphorus are added to SiO₂, an insulating film called FSG (fluorine-doped silicate glass) wherein SiO₂ is doped with fluorine, an insulating film called SiON (silicon oxynitride), and silicon nitride.

Low-dielectric constant interlayer insulating films employable include interlayer insulating films composed of polymers obtained by plasma polymerization of silicon-containing compounds, such as alkoxysilane, silane, alkylsilane, arylsilane, siloxane and alkylsiloxane, in the presence of oxygen, carbon monoxide, carbon dioxide, nitrogen, argon, H₂O, ozone, ammonia or the like, and interlayer insulating films composed of polysiloxane, polysilazane, polyarylene ether, polybenzoxazole, polyimide, silsesquioxane, etc.

The silicon oxide-based insulating film with low-dielectric constant can be obtained by applying a raw material onto a substrate by, for example, a spin coating method and then heating the resulting layer in an oxidative atmosphere.

Examples of the silicon oxide-based insulating films with low-dielectric constant obtained as above include an HSQ film (hydrogen silsesquioxane film) formed using triethoxysilane as a raw material, an MSQ film (methyl silsesquioxane film) formed using tetraethoxysilane and a small amount of methyltrimethoxysilane as raw materials, and insulating films of low dielectric constant formed using other silane compounds as raw materials. If appropriate organic polymer particles are used for the low-dielectric constant insulating film of such a material by mixing them with the material, the organic polymer particles are burned out to form pores during the heating process, and by virtue of formation of such pores, the dielectric constant of the insulating film is further lowered.

The low-dielectric constant insulating film can be also formed by using, as a raw material, an organic polymer, such as a polyarylene-based polymer, a polyallylene ether-based polymer, a polyimide-based polymer or a benzocyclobutene polymer.

The electroless plating solution of the invention is suitable for forming a seed layer composed of a cobalt-based alloy that is a diffusion-preventing film material, on an exposed copper wiring of a semiconductor substrate with extremely high selectivity.

### EXAMPLES

The electroless plating solution of the present invention is further described with reference to the following examples, but it should be construed that the invention is in no way limited to those examples.

A. Case of Using Compound Represented by the Formula (2a) as Surface Active Agent

### Example A1

### (1) Preparation of Electroless Plating Solution

In a glass beaker having a volume of 5000 ml, 2000 ml of an aqueous TMAH solution of 25% by mass heated to 80° C. was placed, and 150 g of tungsten trioxide was added and dissolved in the aqueous TMAH solution.

Next, in another glass beaker having a volume of 5000 ml, 2500 ml of an aqueous TMAH solution of 25% by mass, 850 g of citric acid, 150 g of boric acid and 180 g of cobalt sulfate heptahydrate were placed, and they were mixed to give a solution.

Subsequently, the two solutions prepared as above were mixed, and then, 3 g of 2,4,7,9-tetramethyl-5-decyn-4,7-diol-dipolyoxyethylene ether (available from Air Products and Chemicals, Inc., trade name: Surfynol 465, the sum of the numbers of repeating oxyalkylene units: 10) was added and dissolved.

Then, by use of deionized water and an aqueous TMAH solution of 25% by mass, the mixed solution was adjusted so as to have a pH value of 9.0 and an overall volume of 10 liters.

In the plating solution thus prepared, 20 g of DMAB was dissolved. Thus, a plating solution-A1 was prepared.

### (2) Evaluation of Stability of Electroless Plating Solution

Into a clean glass test tube, 25 ml of the plating solution-A1 prepared above was measured, and to the solution, 0.2 ml of an aqueous palladium chloride solution having a concentration of 0.02 g/liter, which was a catalyst to initiate electroless plating reaction, was added to give a homogenous solution. Thereafter, the solution was heated to 80° C., and the plating solution was observed for any change in state of the solution. In the case the plating solution prepared has insufficient stability, a reduction reaction is initiated by heating the solution in the presence of palladium chloride, and a metal is precipitated.

However, although the plating solution-A1 prepared as above was heated to 80° C., it was free from occurrence of turbidity due to precipitation of a metal over a period of 20 minutes, and the plating solution proved to have sufficient stability.

### (3) Evaluation of Plating Performance

From a commercially available silicon substrate on which a copper foil layer had been formed by plating, a test specimen of 5 cm square was cut out, and the specimen was washed with deionized water. Then, the mass of the specimen (W1) was measured with a precision balance.

Subsequently, the test specimen was immersed for 20 minutes in 100 ml of the plating solution-A1 heated to 80° C.

After the lapse of 20 minutes, the test specimen was taken out and washed with deionized water. As a result, the surface of the test specimen changed to a silver mirror surface, and it was found that the copper surface had been plated with a cobalt-based alloy.

The mass of the test specimen after washing (W2) was measured with a precision balance. From a change of mass after plating (W2−W1), an amount of the metal deposited by plating was calculated, and from the plating time and the area of the test specimen, a plating rate was calculated.

The plating rate of the plating solution-A1 was 0.5 nm/sec.

Next, a silicon substrate with a pattern (substrate with copper damascene wiring made of ATDF, 854CMP001), which had been polished with CMP slurries for copper (available from JSR Corporation, trade names: CMS7401 and CMS7452) and CMP slurries for barrier metal (available from JSR Corporation, trade names: CMS8401 and CMS8452) and had an exposed copper wiring on an insulating film, was prepared, and the silicon substrate was cut out into a test specimen of 3 cm square. This test specimen was washed with deionized water and then immersed for 1 minute in 100 ml of the plating solution-A1 heated to 80° C.

After washing with deionized water again, the plated test specimen was observed with a scanning electron microscope, and it was confirmed that no metal was deposited on the insulating film which should not be essentially plated.

### Example A2

### (1) Preparation of Electroless Plating Solution

In a glass beaker having a volume of 5000 ml, 150 g of tungsten trioxide and 2000 ml of an aqueous TMAH solution of 25% by mass were placed, and they were heated to 80° C. to give a solution.

Next, in another glass beaker having a volume of 5000 ml, 800 g of citric acid and 60 g of cobalt hydroxide were dissolved by the addition of 2000 ml of deionized water to give a solution. Subsequently, the two solutions prepared as above were mixed, and then, 3000 ml of an aqueous TMAH solution of 25% by mass, 300 ml of an aqueous hypophosphorous acid solution of 50% by mass and 150 g of boric acid were added to give a solution.

Further, 30 g of DMAB and 2 g of 2,4,7,9-tetramethyl-5-decyn-4,7-diol-dipolyoxyethylene ether (available from Air Products and Chemicals, Inc., trade name: Surfynol 485, the sum of the numbers of repeating oxyalkylene units: 30) were added and dissolved.

Thereafter, by use of deionized water and an aqueous TMAH solution of 25% by mass, the mixed solution was adjusted so as to have a pH value of 9.0 and an overall volume of 10 liters. Thus, a plating solution-A2 was prepared.

Then, stability and plating performance of the electroless plating solution were evaluated in the same manner as in Example A1, and the results shown in Table 1 were obtained.

### Comparative Example A1

A plating solution-A3 was prepared by the same blending as in the procedure for preparing a plating solution described in Example A1, except that the 2,4,7,9-tetramethyl-5-decyn-4,7-diol-dipolyoxyethylene ether (available from Air Products and Chemicals, Inc., trade name: Surfynol 465) was not used.

### Comparative Example A2

A plating solution-A4 was prepared by the same blending as in the procedure for preparing a plating solution described in Example A2, except that polyoxyethylene nonylphenyl ether phosphoric ester (available from Toho Chemical Industry Co., Ltd., trade name: Phosphanol RE-610) was used instead of the 2,4,7,9-tetramethyl-5-decyn-4,7-diol-dipolyoxyethylene ether (available from Air Products and Chemicals, Inc., trade name: Surfynol 485).

The evaluation results of Comparative Examples A1 and A2 are also set forth in Table 1.

[Table 1]

TABLE 1

| | Ex. A1 | Ex. A2 | Comp. Ex. A1 | Comp. Ex. A2 |
|---|---|---|---|---|
| Plating | Plating | Plating | Plating | Plating |
| Solution | Solution-A1 | Solution-A2 | Solution-A3 | Solution-A4 |
| Plating | 0.5 | 0.4 | 0.3 | 0.4 |
| Rate | | | | |
| (nm/sec) | | | | |
| Stability | >20 min | >20 min | 5 min | >20 min |
| of Plating | | | | |
| Solution, | | | | |
| 80° C. | | | | |
| Result of | Metal | Metal | Metal | Metal |
| Plating | deposition is | deposition is | deposition | deposition |
| Test of | not observed | not observed | due to | due to |
| Substrate | on insulating | on insulating | plating is | plating is |
| with | film between | film between | observed on | observed on |
| Copper | wirings. | wirings. | insulating | insulating |
| Wiring | Plated | Plated | film between | film between |
| | surface is | surface is | wirings. | wirings. |
| | smooth. | smooth. | Co-based | Plated |
| | | | alloy | surface is |
| | | | deposited on | smooth. |
| | | | wiring has | |
| | | | rough | |
| | | | surface. | |

From the above results and comparison with Comparative Example A1, it can be seen that Examples A1 and A2 had a satisfactory plating rate, had stability enough to stabilize plating process, and further had an ability to selectively form a protective film having a copper diffusion-preventing ability only on the surface of an exposed wiring of the semiconductor substrate having a wiring structure using copper or a copper alloy as a wiring material, said selective formation of a protective film being the essential object of the present invention.

From comparison with Comparative Example A2, it can be seen that Examples A1 and A2 had plating solution stability comparable to or higher than that of the plating solution using a conventional surface active agent, and it can be also seen that selectivity to plate only the exposed wiring was improved.

B. Case of Using Sulfonic Acid Type Anionic Surface Active Agent as Surface Active Agent

### Example B1

### (1) Preparation of Electroless Plating Solution

In a glass beaker having a volume of 5000 ml, 2000 ml of an aqueous TMAH solution of 25% by mass heated to 80° C. was placed, and in the aqueous TMAH solution, 150 g of tungsten trioxide was dissolved.

Next, in another glass beaker having a volume of 5000 ml, 2500 ml of an aqueous TMAH solution of 25% by mass, 850 g of citric acid, 150 g of boric acid and 180 g of cobalt sulfate heptahydrate were placed, and they were mixed to give a solution.

Subsequently, the two solutions prepared as above were mixed, and then, 2 g of dodecylbenzenesulfonic acid was dissolved in the mixed solution.

Then, by use of deionized water and an aqueous TMAH solution of 25% by mass, the mixed solution was adjusted so as to have a pH value of 9.0 and an overall volume of 10 liters.

In the plating solution thus prepared, 20 g of DMAB was dissolved. Thus, a plating solution-B1 was prepared.

Then, stability and plating performance of the electroless plating solution were evaluated in the same manner as in Example A1, and the results shown in Table 2 were obtained.

### Example B2

### (1) Preparation of Electroless Plating Solution

In a glass beaker having a volume of 5000 ml, 150 g of tungsten trioxide and 2000 ml of an aqueous TMAH solution of 25% by mass were placed, and they were heated to 80° C. to give a solution.

Next, in another glass beaker having a volume of 5000 ml, 800 g of citric acid and 60 g of cobalt hydroxide were dissolved by the addition of 2000 ml of deionized water to give a solution.

Subsequently, the two solutions prepared as above were mixed, and then, 3000 ml of an aqueous TMAH solution of 25% by mass, 300 ml of an aqueous hypophosphorous acid solution of 50% by mass and 150 g of boric acid were added to the resulting solution to give a solution.

30 g of DMAB and 1 g of ammonium alkyldiphenyl ether disulfonate (available from Nippon Nyukazai Co., Ltd., trade name: Newcol 271-NH) were further added and dissolved in the solution.

Thereafter, by use of deionized water and an aqueous TMAH solution of 25% by mass, the mixed solution was adjusted so as to have a pH value of 9.0 and an overall volume of 10 liters. Thus, a plating solution-B2 was prepared.

Then, stability and plating performance of the electroless plating solution were evaluated in the same manner as in Example A1, and the results shown in Table 2 were obtained.

### Example B3

### (1) Preparation of Electroless Plating Solution

In a glass beaker having a volume of 5000 ml, 2000 ml of an aqueous TMAH solution of 25% by mass heated to 80° C. was placed, and 150 g of tungsten trioxide was added and dissolved in the solution.

Next, in another glass beaker having a volume of 5000 ml, 3500 ml of an aqueous TMAH solution of 25% by mass was placed, and 850 g of citric acid, 150 g of boric acid and 180 g of cobalt sulfate heptahydrate were further mixed and dissolved.

Subsequently, the two solutions prepared as above were mixed, and then, 150 ml of an aqueous hypophosphorous acid solution of 50% by mass, 10 g of N-(2-hydroxyethyl)ethylenediamine-N,N′,N′-triacetic acid and 1 g of naphthalenesulfonic acid formaldehyde condensate ammonium salt were added to the mixed solution to give a solution.

Further, 10 g of DMAB was added, and thereafter, by use of deionized water and an aqueous TMAH solution of 25% by mass, the mixed solution was adjusted so as to have a pH value of 9.0 and an overall volume of 10 liters. Thus, a plating solution-B3 was prepared. Then, stability and plating performance of the electroless plating solution were evaluated in the same manner as in Example A1, and the results shown in Table 2 were obtained.

### Comparative Example B1

A plating solution-B4 was prepared by the same blending as in the procedure for preparing a plating solution described in Example B2, except that the dodecylbenzenesulfonic acid was not used.

### Comparative Example B2

A plating solution-B5 was prepared by the same blending as in the procedure for preparing a plating solution described in Example B2, except that polyoxyethylene nonylphenyl ether phosphoric ester (available from Toho Chemical Industry Co., Ltd., trade name: Phosphanol RE-610) was used instead of the polyoxyethylene tridecyl ether phosphoric ester (available from Toho Chemical Industry Co., Ltd., trade name: Phosphanol RS-610) having an HLB value of 10.5.

The evaluation results of Comparative Examples B1 and B2 are also set forth in Table 2.

[Table 2]

TABLE 2

| | Ex. B1 | Ex. B2 | Ex. B3 | Comp. Ex. B1 | Comp. Ex. B2 |
|---|---|---|---|---|---|
| Plating | Plating | Plating | Plating | Plating | Plating |
| Solution | Solution-B1 | Solution-B2 | Solution-B3 | Solution-B4 | Solution-B5 |
| Plating Rate | 0.6 | 0.5 | 0.3 | 0.3 | 0.4 |
| (nm/sec) | | | | | |
| Stability of | >20 min | >20 min | >20 min | 5 min | >20 min |
| Plating | | | | | |
| Solution, 80° C. | | | | | |
| Result of | Metal | Metal | Metal | Metal | Metal |
| Plating Test | deposition | deposition | deposition | deposition | deposition |
| of Substrate | is not | is not | is not | due to | due to |
| with Copper | observed on | observed on | observed on | plating is | plating is |
| Wiring | insulating | insulating | insulating | observed on | observed on |
| | film between | film between | film between | insulating | insulating |
| | wirings. | wirings. | wirings. | film between | film between |
| | Plated | Plated | Plated | wirings. | wirings. |
| | surface is | surface is | surface is | Co-based | Plated |
| | smooth. | smooth. | smooth. | alloy | surface is |
| | | | | deposited on | smooth. |
| | | | | wiring has | |
| | | | | rough | |
| | | | | surface. | |

From the above results and comparison with Comparative Example B1, it can be seen that Examples B1 to B3 had a satisfactory plating rate, had stability enough to stabilize plating process, and further had an ability to selectively form a protective film having a copper diffusion-preventing ability only on the surface of an exposed wiring of the semiconductor substrate having a wiring structure using copper or a copper alloy as a wiring material, said selective formation of a protective film being the essential object of the present invention.

From comparison with Comparative Example B2, it can be seen that Examples B1 to B3 had plating solution stability comparable to or higher than that of the plating solution using a conventional surface active agent, and it can be also seen that selectivity to plate only the exposed wiring was improved.

C. Case of Using Polyoxyethylene Alkyl Ether Phosphoric Ester as Surface Active Agent

### Example C1

### (1) Preparation of Electroless Plating Solution

In a glass beaker having a volume of 5000 ml, 2000 ml of an aqueous TMAH solution of 25% by mass heated to 80° C. was placed, and 150 g of tungsten trioxide was added and dissolved in the aqueous TMAH solution.

Next, in another glass beaker having a volume of 5000 ml, 500 ml of an aqueous TMAH solution of 25% by mass, 850 g of citric acid, 150 g of boric acid and 180 g of cobalt sulfate heptahydrate were placed to give a solution.

Subsequently, the two solutions prepared as above were mixed, and 3 g of a mixture of phosphoric monoester and diester of polyoxyethylene lauryl ether (available from Dai-Ichi Kogyo Seiyaku Co., Ltd. trade name: Plysurf A219B) was added and dissolved in the mixed solution.

Then, by use of deionized water and an aqueous TMAH solution of 25% by mass, the mixed solution was adjusted so as to have a pH value of 9.0 and an overall volume of 10 liters.

In the plating solution thus prepared, 20 g of DMAB was dissolved. Thus, a plating solution-C1 was prepared.

Then, stability and plating performance of the electroless plating solution were evaluated in the same manner as in Example A1, and the results shown in Table 3 were obtained.

### Example C2

### (1) Preparation of Electroless Plating Solution

In a glass beaker having a volume of 5000 ml, 150 g of tungsten trioxide and 2000 ml of an aqueous TMAH solution of 25% by mass were placed, and they were heated to 80° C. to give a solution.

Next, in another glass beaker having a volume of 5000 ml, 800 g of citric acid and 60 g of cobalt hydroxide were dissolved by the addition of 2000 ml of deionized water to give a solution.

Subsequently, the two solutions prepared as above were mixed, and then, 3000 ml of an aqueous TMAH solution of 25% by mass, 300 ml of an aqueous hypophosphorous acid solution of 50% by mass and 150 g of boric acid were added to the mixed solution to give a solution.

30 g of DMAB and 1 g of polyoxyethylene tridecyl ether phosphoric ester (available from Toho Chemical Industry Co., Ltd., trade name: Phosphanol RS-610) having an HLB value of 10.5 were further added and dissolved in the resulting solution.

Thereafter, by use of deionized water and an aqueous TMAH solution of 25% by mass, the mixed solution was adjusted so as to have a pH value of 9.0 and an overall volume of 10 liters. Thus, a plating solution-C2 was prepared.

Then, stability and plating performance of the electroless plating solution were evaluated in the same manner as in Example A1, and the results shown in Table 3 were obtained.

### Example C3

### (1) Preparation of Electroless Plating Solution

In a glass beaker having a volume of 5000 ml, 2000 ml of an aqueous TMAH solution of 25% by mass heated to 80° C. was placed, and 150 g of tungsten trioxide was added and dissolved in the aqueous TMAH solution.

Next, in another glass beaker having a volume of 5000 ml, 3500 ml of an aqueous TMAH solution of 25% by mass was placed, and 850 g of citric acid, 150 g of boric acid and 180 g of cobalt sulfate heptahydrate were added and dissolved in the aqueous TMAH solution.

Subsequently, the two solutions prepared as above were mixed, and then, 150 ml of an aqueous hypophosphorous acid solution of 50% by mass, 10 g of N-(2-hydroxyethyl)ethylenediamine-N,N′,N′-triacetic acid and 0.1 g of polyoxyethylene tridecyl ether phosphoric ester (available from Toho Chemical Industry Co., Ltd., trade name; Phosphanol RS-710) having an HLB value of 13.3 were added to the mixed solution to give a solution.

To the resulting solution, 10 g of DMAB was further added, and thereafter, by use of deionized water and an aqueous TMAH solution of 25% by mass, the mixed solution was adjusted so as to have a pH value of 9.0 and an overall volume of 10 liters. Thus, a plating solution-C3 was prepared.

Then, stability and plating performance of the electroless plating solution were evaluated in the same manner as in Example A1, and the results shown in Table 3 were obtained.

### Comparative Example C1

A plating solution-C4 was prepared by the same blending as in the procedure for preparing a plating solution described in Example C2, except that the mixture of phosphoric monoester and diester of polyoxyethylene lauryl ether (available from Dai-Ichi Kogyo Seiyaku Co., Ltd. trade name: Plysurf A219B) was not used.

### Comparative Example C2

A plating solution-C5 was prepared by the same blending as in the procedure for preparing a plating solution described in Example C2, except that polyoxyethylene nonylphenyl ether phosphoric ester (available from Toho Chemical Industry Co., Ltd., trade name: Phosphanol RE-610) was used instead of the polyoxyethylene tridecyl ether phosphoric ester (available from Toho Chemical Industry Co., Ltd., trade name: Phosphanol RS-610) having an HLB value of 10.5.

The evaluation results of Comparative Examples C1 and C2 are also set forth in Table 3.

[Table 3]

TABLE 3

| | Ex. C1 | Ex. C2 | Ex. C3 | Comp. Ex. C1 | Comp. Ex. C2 |
|---|---|---|---|---|---|
| Plating | Plating | Plating | Plating | Plating | Plating |
| Solution | Solution-C1 | Solution-C2 | Solution-C3 | Solution-C4 | Solution-C5 |
| Plating Rate | 0.4 | 0.5 | 0.4 | 0.3 | 0.4 |
| (nm/sec) | | | | | |
| Stability of | >20 min | >20 min | >20 min | 5 min | >20 min |
| Plating | | | | | |
| Solution, 80° C. | | | | | |
| Result of | Metal | Metal | Metal | Metal | Metal |
| Plating Test | deposition | deposition | deposition | deposition | deposition |
| of Substrate | is not | is not | is not | due to | due to |
| with Copper | observed on | observed on | observed on | plating is | plating is |
| Wiring | insulating | insulating | insulating | observed on | observed on |
| | film between | film between | film between | insulating | insulating |
| | wirings. | wirings. | wirings. | film between | film between |
| | Plated | Plated | Plated | wirings. | wirings. |
| | surface is | surface is | surface is | Co-based | Plated |
| | smooth. | smooth. | smooth. | alloy | surface is |
| | | | | deposited on | smooth. |
| | | | | wiring has | |
| | | | | rough | |
| | | | | surface. | |

From the above results and comparison with Comparative Example C1, it can be seen that Examples C1 to C3 had a satisfactory plating rate, had stability enough to stably carry out plating treatment, and further had an ability to selectively form a protective film having a copper diffusion-preventing ability only on the surface of an exposed wiring of the semiconductor substrate having a wiring structure using copper or a copper alloy as a wiring material, said selective formation of a protective film being the essential object of the present invention.

From comparison with Comparative Example C2, it can be seen that Examples C1 to C3 had plating solution stability comparable to or higher than that of the plating solution using a conventional surface active agent, and it can be also seen that selectivity to plate only the exposed wiring was improved.

D. Case of Using Polyoxyalkylene Monoalkyl Ether as Surface Active Agent

### Example D1

### (1) Preparation of Electroless Plating Solution

In a glass beaker having a volume of 5000 ml, 2000 ml of an aqueous TMAH solution of 25% by mass heated to 80° C. was placed, and 150 g of tungsten trioxide was added and dissolved in the aqueous TMAH solution.

Next, in another glass beaker having a volume of 5000 ml, 2500 ml of an aqueous TMAH solution of 25% by mass was placed, and 850 g of citric acid, 150 g of boric acid and 180 g of cobalt sulfate heptahydrate were added and dissolved in the aqueous TMAH solution.

Subsequently, the two solutions prepared as above were mixed, and 3 g of polyoxyethylene tridecyl ether (available from Dai-Ichi Kogyo Seiyaku Co., Ltd. trade name: Noigen TDS-80) having an HLB value of 13.3 was added and dissolved in the mixed solution.

By the addition of deionized water and an aqueous TMAH solution of 25% by mass, the mixed solution was adjusted so as to have a pH value of 9.0 and an overall volume of 10 liters.

In the plating solution thus prepared, 20 g of DMAB was dissolved. Thus, a plating solution-D1 was prepared.

Then, stability and plating performance of the electroless plating solution were evaluated in the same manner as in Example A1, and the results shown in Table 4 were obtained.

### Example D2

### (1) Preparation of Electroless Plating Solution

In a glass beaker having a volume of 5000 ml, 150 g of tungsten trioxide and 2000 ml of an aqueous TMAH solution of 25% by mass were placed, and they were heated to 80° C. and the tungsten trioxide was dissolved in the aqueous TMAH solution.

Next, in another glass beaker having a volume of 5000 ml, 800 g of citric acid and 60 g of cobalt hydroxide were dissolved by the addition of 2000 ml of deionized water to give a solution.

Subsequently, the two solutions prepared as above were mixed, and then, 3000 ml of an aqueous TMAH solution of 25% by mass, 300 ml of an aqueous hypophosphorous acid solution of 50% by mass and 150 g of boric acid were added to the mixed solution to give a solution.

Further, 30 g of DMAB and 1 g of polyoxyalkylene isodecyl ether (available from Dai-Ichi Kogyo Seiyaku Co., Ltd. trade name: Noigen XL-100) having an HLB value of 14.7 were added and dissolved.

Thereafter, by use of deionized water and an aqueous TMAH solution of 25% by mass, the mixed solution was adjusted so as to have a pH value of 9.0 and an overall volume 10 liters. Thus, a plating solution-D2 was prepared.

Then, stability and plating performance of the electroless plating solution were evaluated in the same manner as in Example A1, and the results shown in Table 4 were obtained.

### Example D3

### (1) Preparation of Electroless Plating Solution

In a glass beaker having a volume of 5000 ml, 2000 ml of an aqueous TMAH solution of 25% by mass heated to 80° C. was placed, and 150 g of tungsten trioxide was added and dissolved in the aqueous TMAH solution.

Next, in another glass beaker having a volume of 5000 ml, 3500 ml of an aqueous TMAH solution of 25% by mass, 850 g of citric acid, 150 g of boric acid and 180 g of cobalt sulfate heptahydrate were placed, and they were mixed to give a solution.

Subsequently, the two solutions prepared as above were mixed, and then, 150 ml of an aqueous hypophosphorous acid solution of 50% by mass, 10 g of N-(2-hydroxyethyl)ethylenediamine-N,N′,N′-triacetic acid and 0.1 g of polyoxyalkylene lauryl ether (available from Dai-Ichi Kogyo Seiyaku Co., Ltd. trade name: DKS NL-Dash 410) having an HLB value of 12.5 were added to the mixed solution to give a solution.

Further, 10 g of DMAB was added, and thereafter, by use of deionized water and an aqueous TMAH solution of 25% by mass, the mixed solution was adjusted so as to have a pH value of 9.0 and an overall volume of 10 liters. Thus, a plating solution-D3 was prepared.

Then, stability and plating performance of the electroless plating solution were evaluated in the same manner as in Example A1, and the results shown in Table 4 were obtained.

### Example D4

### (1) Preparation of Electroless Plating Solution

In a glass beaker having a volume of 5000 ml, 150 g of tungsten trioxide and 2000 ml of an aqueous TMAH solution of 25% by mass were placed, and they were heated to 80° C. and the tungsten trioxide was dissolved in the solution.

Next, in another glass beaker having a volume of 5000 ml, 800 g of citric acid and 60 g of cobalt hydroxide were dissolved by the addition of 2000 ml of deionized water to give a solution.

Subsequently, the two solutions prepared as above were mixed, and then, 3000 ml of an aqueous TMAH solution of 25% by mass, 300 ml of an aqueous hypophosphorous acid solution of 50% by mass and 150 g of boric acid were added to the mixed solution to give a solution.

Further, 30 g of DMAB and 0.5 g of polyoxyethylene isodecyl ether (available from Dai-Ichi Kogyo Seiyaku Co., Ltd. trade name: Noigen SD-70) having an HLB value of 13.2 were added and dissolved.

Thereafter, by use of deionized water and an aqueous TMAH solution of 25% by mass, the mixed solution was adjusted so as to have a pH value of 9.0 and an overall volume of 10 liters. Thus, a plating solution-D4 was prepared.

Then, stability and plating performance of the electroless plating solution were evaluated in the same manner as in Example A1, and the results shown in Table 4 were obtained.

### Example D5

### (1) Preparation of Electroless Plating Solution

In a glass beaker having a volume of 5000 ml, 2000 ml of an aqueous TMAH solution of 25% by mass heated to 80° C. was placed, and 150 g of tungsten trioxide was added and dissolved in the aqueous TMAH solution.

Next, in another glass beaker having a volume of 5000 ml, 2500 ml of an aqueous TMAH solution of 25% by mass, 850 g of citric acid, 150 g of boric acid and 180 g of cobalt sulfate heptahydrate were placed to give a solution.

Subsequently, the two solutions prepared as above were mixed, and then, 2 g of polyoxyalkylene tridecyl ether (available from Dai-Ichi Kogyo Seiyaku Co., Ltd. trade name: Noigen TDX-80D) having an HLB value of 13.1 was added and dissolved in the mixed solution.

Then, by use of deionized water and an aqueous 2-hydroxyethyltrimethylammonium hydroxide solution of % by mass, the mixed solution was adjusted so as to have a pH value of 9.0 and an overall volume of 10 liters.

20 g of DMAB was added and dissolved in the resulting solution. Thus, a plating solution-D5 was prepared.

Then, stability and plating performance of the electroless plating solution were evaluated in the same manner as in Example A1, and the results shown in Table 4 were obtained.

### Comparative Example D1

A plating solution-D6 was prepared by the same blending as in the procedure for preparing a plating solution described in Example D2, except that the polyoxyalkylene isodecyl ether (available from Dai-Ichi Kogyo Seiyaku Co., Ltd. trade name: Noigen XL-100) having an HLB value of 14.7 was not used.

### Comparative Example D2

A plating solution-D7 was prepared by the same blending as in the procedure for preparing a plating solution described in Example D1, except that polyoxyethylene octylphenyl ether (available from the Dow Chemical company, trade name: Triton X-100) having an HLB value of 13.5 was used instead of the polyoxyethylene tridecyl ether (available from Dai-Ichi Kogyo Seiyaku Co., Ltd. trade name: Noigen TDS-80) having an HLB value of 13.3.

The evaluation results of Comparative Examples D1 and D2 are also set forth in Table 4.

[Table 4]

TABLE 4

| | Ex. D1 | Ex. D2 | Ex. D3 | Ex. D4 | Ex. D5 | Comp. Ex. D1 | Comp. Ex. D2 |
|---|---|---|---|---|---|---|---|
| Plating | Plating | Plating | Plating | Plating | Plating | Plating | Plating |
| Solution | Solution-D1 | Solution-D2 | Solution-D3 | Solution-D4 | Solution-D5 | Solution-D6 | Solution-D7 |
| Plating Rate | 0.5 | 0.4 | 0.3 | 0.4 | 0.4 | 0.3 | 0.4 |
| (nm/sec) | | | | | | | |
| Stability of | >20 min | >20 min | >20 min | >20 min | >20 min | 5 min | >20 min |
| Plating | | | | | | | |
| Solution, 80° C. | | | | | | | |
| Result of | Metal | Metal | Metal | Metal | Metal | Metal | Metal |
| Plating Test of | deposition | deposition | deposition | deposition | deposition | deposition | deposition |
| Substrate with | is not | is not | is not | is not | is not | due to | due to |
| Copper Wiring | observed on | observed on | observed on | observed on | observed on | plating is | plating is |
| | insulating | insulating | insulating | insulating | insulating | observed on | observed on |
| | film | film | film | film | film | insulating | insulating |
| | between | between | between | between | between | film | film |
| | wirings. | wirings. | wirings. | wirings. | wirings. | between | between |
| | Plated | Plated | Plated | Plated | Plated | wirings. | wirings. |
| | surface is | surface is | surface is | surface is | surface is | Co-based | Plated |
| | smooth. | smooth. | smooth. | smooth. | smooth. | alloy | surface is |
| | | | | | | deposited | smooth. |
| | | | | | | on wiring | |
| | | | | | | has rough | |
| | | | | | | surface. | |

From the above results and comparison with Comparative Example D1, it can be seen that Examples D1 to D5 had a satisfactory plating rate, had stability enough to stably carry out plating treatment, and further had an ability to selectively form a protective film having a copper diffusion-preventing ability only on the surface of an exposed wiring of the semiconductor substrate having a wiring structure using copper or a copper alloy as a wiring material, said selective formation of a protective film being the essential object of the present invention.

From comparison with Comparative Example D2, it can be seen that Examples D1 to D5 had plating solution stability comparable to or higher than that of the plating solution using a conventional surface active agent, and it can be also seen that selectivity to plate only the exposed wiring was improved.

### INDUSTRIAL APPLICABILITY

In the production of a semiconductor device having a wiring structure using copper or a copper alloy as a wiring material, formation of a protective film by electroless plating has been proposed as an effective means to selectively form a protective film having a copper diffusion-preventing ability on a surface of an exposed wiring. The electroless plating solution of the invention is an electroless plating solution used for selectively forming a protective film on a surface of an exposed wiring in the production of a semiconductor device having a wiring structure, and includes a cobalt ion, an ion of a second metal other than cobalt, a chelating agent, a reducing agent, a surface active agent and a tetraalkylammonium hydroxide represented by the following formula (1):

R¹R²R³R⁴NOH (1)

wherein R¹, R², R³ and R⁴ are each independently one group selected from the group consisting of an alkyl group and a hydroxyalkyl group, and

the surface active agent is selected from the group consisting of a compound represented by the following formula (2a) or (2b), a sulfonic acid type anionic surface active agent, a polyoxyethylene alkyl ether phosphoric ester and a polyoxyalkylene monoalkyl ether,

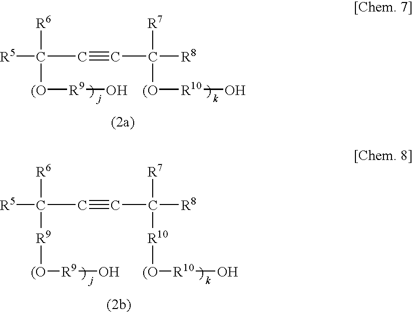

wherein R⁵ to R⁸ are each independently a hydrogen atom or a substituted or unsubstituted alkyl group of 1 to 5 carbon atoms, R⁹ is an alkylene group of 2 to 5 carbon atoms, and when plural alkylene groups indicated by R⁹ are present, they may be the same as or different from one another, R¹⁰ is an alkylene group of 2 to 5 carbon atoms, and when plural alkylene groups indicated by R¹⁰ are present, they may be the same as or different from one another, j and k are each independently an integer of not less than 1, and the sum of j and k is 2 to 50.

The electroless plating solution having the above constitution can form a protective film of a cobalt-based alloy only on a wiring of copper or the like with excellent selectivity, does not cause surface contamination of the exposed wiring, and can prevent electromigration into an interlayer insulating film laminated. By use of the electroless plating solution of the invention, further, a seed layer such as a palladium layer does not need to be formed. Therefore, there is no fear of increase of wiring resistance, and a fear of deposition of a plating metal on a part other than the wiring, which is caused by adhesion of palladium onto an insulator in addition to the wiring part, can be avoided. In the present invention, furthermore, without using endocrine disruptors (environmental hormones), such as polyoxyethylene octylphenyl ether and polyoxyethylene nonylphenyl ether which are conventionally used, their performance can be attained, and hence, the influence on the electroless plating workers and the surrounding environment can be inhibited.

1. An electroless plating solution used for selectively forming a protective film on a surface of an exposed wiring in the production of a semiconductor device having a wiring structure, wherein:
the electroless plating solution comprises a cobalt ion, an ion of a second metal other than cobalt, a chelating agent, a reducing agent, a surface active agent and a tetraalkylammonium hydroxide represented by the following formula (1):
R¹R²R³R⁴NOH (1)
wherein R¹, R², R³ and R⁴ are each independently one group selected from the group consisting of an alkyl group and a hydroxyalkyl group, and
the surface active agent is selected from the group consisting of a compound represented by the following formula (2a) or (2b), a sulfonic acid type anionic surface active agent, a polyoxyethylene alkyl ether phosphoric ester and a polyoxyalkylene monoalkyl ether, 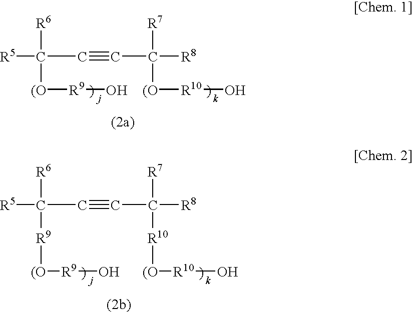
wherein R⁵ to R⁸ are each independently a hydrogen atom or a substituted or unsubstituted alkyl group of 1 to 5 carbon atoms, R⁹ is an alkylene group of 2 to 5 carbon atoms, and when a plurality of R⁹ are present, they may be the same as or different from one another, R¹⁰ is an alkylene group of 2 to 5 carbon atoms, and when a plurality of R¹⁰ are present, they may be the same as or different from one another, j and k are each independently an integer of not less than 1, and the sum of j and k is 2 to 50.

2. The electroless plating solution as claimed in claim 1, wherein the surface active agent is a compound represented by the following formula (2a) or (2b): 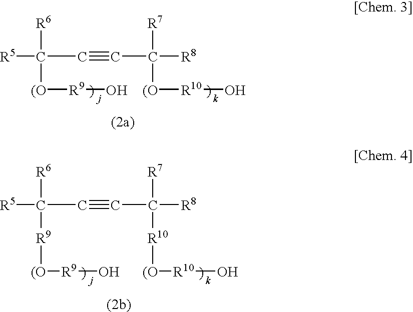
wherein R⁵ to R⁸ are each independently a hydrogen atom or a substituted or unsubstituted alkyl group of 1 to 5 carbon atoms, R⁹ is an alkylene group of 2 to 5 carbon atoms, and when a plurality of R⁹ are present, they may be the same as or different from one another, R¹⁰ is an alkylene group of 2 to 5 carbon atoms, and when a plurality of R¹⁰ are present, they may be the same as or different from one another, j and k are each independently an integer of not less than 1, and the sum of j and k is 2 to 50.

3. The electroless plating solution as claimed in claim 2, wherein the compound represented by the formula (2a) is 2,4,7,9-tetramethyl-5-decyn-4,7-diol-dipolyoxyethylene ether, wherein the sum of numbers of repeating oxyalkylene units is 10, and/or 2,4,7,9-tetramethyl-5-decyn-4,7-diol-dipolyoxyethylene ether, wherein the sum of numbers of repeating oxyalkylene units is 30.

4. The electroless plating solution as claimed in claim 2, wherein the reducing agent contains no alkali metal.

5. The electroless plating solution as claimed in claim 2, wherein an alkali metal is not contained in a component for adjusting a pH value of the electroless plating solution.

6. The electroless plating solution as claimed in claim 1, wherein the surface active agent is a sulfonic acid type anionic surface active agent.

7. The electroless plating solution as claimed in claim 1, wherein the surface active agent is a polyoxyethylene alkyl ether phosphoric ester.

8. The electroless plating solution as claimed in claim 7, wherein the polyoxyethylene alkyl ether phosphoric ester is represented by the following formula (3):
[R¹¹O—(CH₂CH₂O)ₙ]ₘ—H₃₋ₘPO₄₋ₘ (3)
wherein R¹¹ is a hydrocarbon group of 10 or more carbon atoms, n is an integer of not less than 5 and less than 30, and m is 1 or 2.

9. The electroless plating solution as claimed in claim 8, wherein the hydrocarbon group indicated by R¹¹ in the formula (3) is at least one group selected from the group consisting of a decyl group, an isodecyl group, a lauryl group, a tridecyl group, a cetyl group, an oleyl group and a stearyl group.

10. The electroless plating solution as claimed in claim 1, wherein the surface active agent is a polyoxyalkylene monoalkyl ether.

11. The electroless plating solution as claimed in claim 1, wherein the second metal other than cobalt is a fourth period metal of the periodic table of elements other than cobalt, a fifth period metal of the periodic table of elements or a sixth period metal of the periodic table of elements.

12. The electroless plating solution as claimed in claim 11, wherein the second metal other than cobalt is tungsten and/or molybdenum, and
the source of supply of an ion of the second metal is at least one compound selected from the group consisting of:
metal oxides consisting of tungsten dioxide, tungsten trioxide, molybdenum dioxide and molybdenum trioxide;
metal salts consisting of tungsten pentachloride and tungsten hexachloride; and
tungstic acid, molybdic acid, tungstate, molybdate, heteropoly-acid of tungstophosphoric acid, and a salt of heteropoly-acid of tungstophosphoric acid.

13. The electroless plating solution as claimed in claim 1, wherein the reducing agent is alkylamine borane.
